(19) United States
(12) Patent Application Publication
(10) Pub. No.: US 2026/0296797 A1
(43) Pub. Date: Oct. 1, 2026

(54) STORAGE OF GRANULAR COMPOSITIONS

(71) Applicant: Dean Grose, Eighty Four, PA (US)

(72) Inventor: Dean Grose, Eighty Four, PA (US)

(21) Appl. No.: 19/092,566

(22) Filed: Mar. 27, 2025

(51) Int. Cl. B65G 47/19

(52) U.S. Cl. CPC B65G 47/19

(57) ABSTRACT

A granule transfer and storage apparatus. The granule transfer and storage apparatus includes a granule receiving platform, a granule transfer device, a small mesh granule storage site having a small mesh granule storage container, and a large mesh granule storage site having a large mesh granule storage container.

### CROSS-REFERENCE TO RELATED APPLICATIONS

None

### BACKGROUND

### Field of the Disclosure

The present disclosure relates generally to storage of granular materials and particularly to storing various size granules in separate locations.

### Description of the Related Art

U.S. Patent Application Pub. No. 20190100391 discloses a Transport, Loading and Storage System for Granular Materials. The invention is said to be for use in hydraulic fracturing applications in paragraph 2. That reference discloses a tractor-trailer carrying granular material, such as sand, being driven to a project site where a bottom exit of the trailer is centered over a conveyor. The granular material exits the trailer through its bottom exit onto the conveyor. The granular material is transferred by the conveyor into a surge hopper, then into a transfer pipe through which it is forced by a blower into a designated silo.

There may be multiple silos in U.S. Patent Application Pub. No. 20190100391, with silo content level monitored using sonic, radar, optical, inductive or mechanical level monitors. Discharge of granular material may be automatically switched from one silo to another silo if one silo becomes full using a programmable logic control unit (PLC). Discharge of granular material may be directed to a particular silo if that silo's content falls below a predetermined level.

Hopper level in U.S. Patent Application Pub. No. 20190100391 may also be monitored by a PLC and the PLC can automatically control the rate of filling or emptying the surge hopper to maintain the contents within pre-determined levels.

A variety of materials are used in operations that produce natural gas and oil. For example, in fracking operations water, salt, chemicals, and granular material such as sand may be used.

It is thought that granules of different sizes could beneficially be used at different periods or stages of an extraction operation.

Accordingly, there is a need to store sand, silica, or other granules or compositions of different sizes or diameters, herein referred to as meshes, separately by mesh size.

There is a need to draw sand, silica, or other granules or compositions of different mesh sizes at appropriate times as need for the operation.

There is a need to sense the mesh size of sand, silica, or other granules or compositions of different mesh sizes separately by mesh size delivered to an operational site.

There is a need to move sand, silica, or other granules or compositions of different mesh sizes separately by mesh size from a truck or other delivery vehicle delivering sand, silica, or other granules or compositions of different mesh sizes separately by mesh size to an operational site, such as a fracking operation or an industrial processing or manufacturing operation, to separate storage areas, staging sites, containers, or other storage areas, temporarily or for an intermediate time until the sand, silica, or other granules or compositions of different mesh sizes are required, for example in the fracking or other operation conducted on the operational site.

There is also a need to move those granules separated by mesh size to a fracking well or other operation.

There may be a need to sense when a granule mesh container or storage area is filled.

There may be a need to have a secondary storage container or area for granules of a certain mesh to be placed.

There may be a need for granule mesh to be diverted to such a secondary storage container or area when a primary storage container or area is full or filled beyond a desired level.

There may also be a need to sense the fill level of a granule mesh container or storage area.

There may also be a need to alert a person when a granule mesh container or storage area reaches a predetermined level.

There is also a need to efficiently manage delivery and storage of sand and silica type materials.

There may be a need to track the location of a delivery truck.

There may be a need to track what portion of a delivery operation a truck is performing.

There may be a need to determine how much time is passing at one or more portion of a delivery operation.

There may further be a need to provide support for a delivery truck taking more time than expected in an operation or a portion of an operation.

There is a need to track when a truck is on a delivery site.

There is a need to track when a truck completes its delivery.

There is a need to dispatch or provide instructions to a driver at various stages of a pickup and delivery run.

There is also a need to know when a truck is operating off a schedule or taking longer than expected to perform a task.

There ma also be a need to provide assistance to a truck operator who is running behind schedule.

Accordingly, the present invention provides solutions to the shortcomings of hauling, storing and providing granule meshes of varying size to an operation. Those of ordinary skill in the art will readily appreciate, therefore, that those and other details, features, and advantages of the present invention will become further apparent in the following detailed description of the preferred embodiments of the invention.

### BRIEF DESCRIPTION OF THE DRAWINGS

The above-mentioned and other features and advantages of this disclosure, and the manner of attaining them, will become more apparent and the disclosure itself will be better understood by reference to the following descriptions of embodiments of the disclosure taken in conjunction with the accompanying drawings, wherein:

FIG. 1 illustrates an embodiment of a granular material storage site;

FIG. 2 illustrates an embodiment of a granular material communication system;

FIG. 3 illustrates an embodiment of a processor-based controller for use in a granular material storage system;

FIG. 4 illustrates an embodiment of a method of transferring and storing different size or mesh of granules; and

FIG. 5 illustrates elements that may be used in embodiments of operation of a granule transfer and storage apparatus.

Corresponding reference characters indicate corresponding parts throughout the several views. The exemplifications set out herein illustrate exemplary aspects of the disclosure, and such exemplifications are not to be construed as limiting the scope of the disclosure in any manner.

### SUMMARY OF THE INVENTION

In an embodiment, a granule transfer and storage apparatus includes a granule receiving platform, a granule transfer device, a small mesh granule storage site having a first small mesh granule storage container, and a large mesh granule storage site having a first large mesh granule storage container. The small mesh granule storage container includes a small mesh granule valve and an actuator for the small mesh granule valve and the large mesh granule storage container includes a large mesh granule valve and an actuator for the large mesh granule valve. When closed, the small mesh granule valve prevents entry of materials into the small mesh storage container and when open the small mesh granule valve restricts access to the small mesh storage container. When closed, the large mesh granule valve prevents entry of materials into the large mesh storage container and when open the large mesh granule valve restricts access to the large mesh storage container.

In an embodiment, the granule transfer and storage apparatus includes a controller that has a plurality of inputs and a plurality of outputs. A first switch coupled to a first input on the controller provides a signal to the controller that indicates whether the first small mesh granule valve is open and a second switch couped to a second input of the controller provides a signal to the controller that indicates whether the first small mesh granule valve is closed. A first controller output is coupled to the first small mesh granule valve in accordance with instructions that, when executed by the controller, cause the controller to modulate, open, close, or otherwise move the first small mesh granule valve. A third switch coupled to a third input on the controller provides a signal to the controller that indicates whether the first large mesh granule valve is open and a fourth switch couped to a fourth input of the controller provides a signal to the controller that indicates whether the first large mesh granule valve is closed. A second controller output is coupled to the first large mesh granule valve in accordance with instructions that, when executed by the controller, cause the controller to modulate, open, close, or otherwise move the first large mesh granule valve.

A method of transferring and storing different size granules includes categorizing the granule by size, depositing the granules on a granule receiving platform, transferring the granules to a site designated for granules of the size of the granules deposited on the granule receiving platform, opening a container for the granules, placing the granules in the container, and closing the container.

Other embodiments, which may include one or more portions of the aforementioned apparatuses and methods or other parts or elements, are also contemplated, and may have a broader or different scope than the aforementioned apparatuses and methods. Thus, the embodiments in this Summary of the Invention are mere examples, and are not intended to limit or define the scope of the invention or claims.

### DETAILED DESCRIPTION OF THE INVENTION

The following description is provided to enable those skilled in the art to make and use the described embodiments contemplated for carrying out the concept. Various modifications, equivalents, variations, and alternatives, however, will remain readily apparent to those skilled in the art. Any and all such modifications, variations, equivalents, and alternatives are intended to fall within the spirit and scope of the present concept.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification do not necessarily all refer to the same embodiment. References to “or” are furthermore intended as inclusive, so “or” may indicate one or another of the ored terms or more than one ored term.

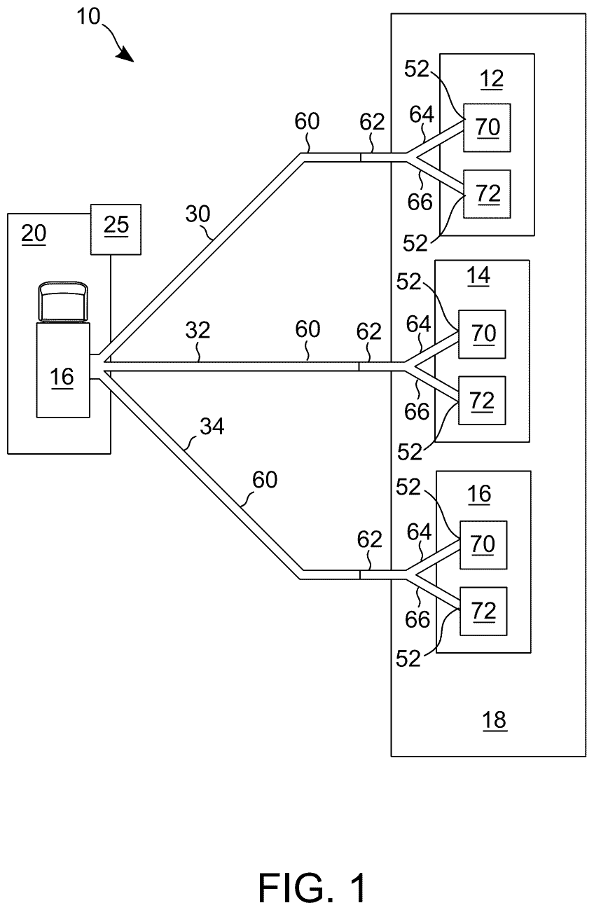

FIG. 1 illustrates an embodiment of a granular material storage system 10 where sand, silica, or other granules or compositions of different sizes or diameters are stored separately by mesh size in repositories 12, 14, 16 on the granular material storage site 18. (Sizes of individual grains of granules in a load of granular material 16, which may be average sizes or estimated sizes, are herein referred to as meshes or mesh sizes.) In the embodiment illustrated in FIG. 1, a granular material delivery pad 20 is provided for receipt of granular material. An operator or an input device 25 is provided to determine the mesh size of the granules deposited or to be deposited on the delivery pad 20. A first transport device 30 is provided leading from the delivery pad 20 to a first granule mesh storage position or repository 12. A second transport device 32 is provided leading from the delivery pad 20 to a second granule mesh storage position or repository 14. A third transport device 34 is provided leading from the delivery pad 20 to a third granule mesh storage position 16. A single transport device 30 may be used for multiple granule mesh storage positions 12, 14, 16 by, for example, moving or rotating the transport device 30 such that the transport device 30 delivers the granules to the appropriate granule mesh storage repository 12, 14, 16. It should be recognized that four or any other number of storage positions 12, 14, 16 and four or any other number of transport devices 30, 32, 34 may be provided to deliver granules of varying meshes to four or any other number if granule mesh storage positions 12, 14, 16.

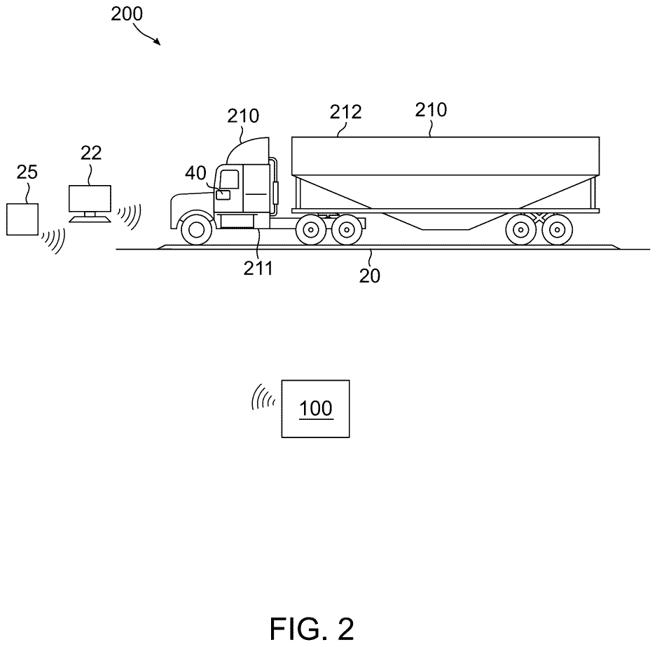

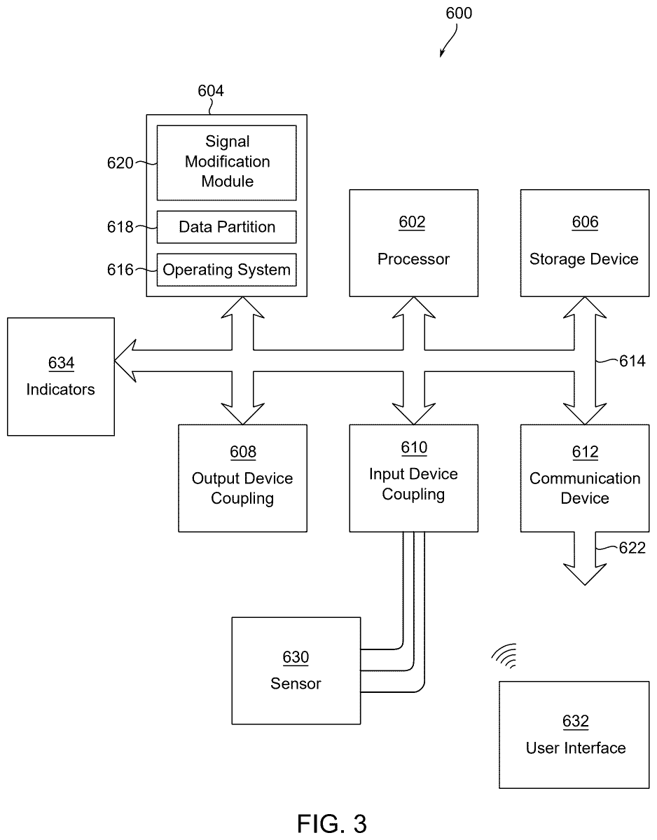

FIG. 2 illustrates a granular material communication system 200 that may include a tanker truck 210 prepared to unload on a delivery pad 20. The tanker truck 210 includes a tractor 211 attached to a tank 212, a sand box, or another granular material hauling vessel. An operator terminal 22 or an input device 25 may communicate with a processor-based granular material storage system control device 100. The processor-based device may be a control system 600 as illustrated and discussed in connection with FIG. 3 and may be provided to receive information about a load of granules being delivered. The processor-based device 100 may be coupled to the operator terminal 22 or the input device 25 by wires or wirelessly, for example at the processor-based device 100 input/output device. The user interface 22, 25 may communicate with the processor-based device 100. The user interface 22, 25 may, for example, be a multi-function communication device, such as an Apple iPhone, a Samsung Galaxy wireless phone, another wireless phone device, a tablet device, or another computing device. The user interface 22, 25 may require input of a password, user facial identification, or other validation to access information contained within the processor-based device 100. The operator terminal 22 or input device 25 may, furthermore, both access data held in the processor-based device 100 and configure the processor-based device 100. A communication device 40, such as a fob, may be associated with a truck 210 or truck operator and may transmit information, including information about the truck 210, it load, its driver, or its owner.

The truck 210 in this embodiment also includes a locating device 40, such as an RFID transmitter, geofencing, a magnetic sensor, or a global positioning device, which may determine the relationship of the truck 210 to the granular material storage site 18, the granular material delivery pad 20, or various repositories. The location device may transmit or be read by a location device mounted along the path of the truck, such as on a gate through which one or more trucks is expected to pass, on or in pavement over which a truck is expected to pass, or on a bar under which a truck is expected to pass.

The operator terminal 22 and input device 25 may be processor-based devices having components discussed in connection with the processor-based device 600 illustrated in FIG. 3 and may communicate with other processor-based devices 22, 25, 100 by Bluetooth, ZigBee, or other wireless protocol, by RFID, or by displaying or reading a code, and may be carried by an operator associated with the delivery of the granules or provided with the load of granules, for example.

In embodiments, mesh size may be read by a marking such as a universal product code (UPC) Quick-Response (QR) code, and various codes, and tags, written documents or other systems from a document in paper, on a screen, or presented otherwise from, for example, a purchase order or a delivery document, which may be carried and presented by a truck 210 or other vehicle delivering the granules or an operator associated with the delivery of the granules.

A processor-based device 100, such as the processor-based controller 600 illustrated in FIG. 3, may be utilized to sense characteristics of a load of granular material. Characteristics of a load of granular material may include the volume, weight, or quantity of granules being delivered in a current load, the source of the granules being delivered, the delivery company delivering the granules, the person delivering the granules, or the method of delivering the granules, such as a particular type of truck, train car, or container, such as what is commonly referred to as a sand box, used in the delivery. That information may be provided automatically or manually by way of an operator terminal 22 carried with the load of granules or supplied at the granular material storage site 18, by scanning a code, tag, or other marking associated with a bill of lading, or otherwise as desired. In an embodiment, the weight of a load of granules is measured at the pad 20 by, for example, a scale associated with the pad 20 or situated under the pad 20 to measure wight applied to the pad 20.

The quantity of granules is measured, in one embodiment, in units of weight. The amount that a tank, silo, hopper, or other container at a granule mesh storage position 12, 14, 16 may be determined in that embodiment by sensed level, weight, as provided for example by a load cell, or otherwise as desired. When a container at a granule mesh storage position 12, 14, 16 reaches a predetermined level or weight, even when that container is in the process of receiving granules and that load has not been fully unloaded in that container, loading of that container may be terminated by an operator or the processor-based device 100. Where a conveyor 30, 32, 34, 64, 66 or other transport is used, granules may be diverted and placed in a second silo, tank or other container at the same granule mesh storage position 12, 14, 16. For example, where a load of granules is deposited on a delivery pad 20 and a conveyor belt 60 transport device 30, 32, 34 is carrying the granules to a granule mesh storage position 12, 14, 16, the conveyor belt 30, 32, 34 may deliver the granules to a wye-belt conveyor 62 that has a first belt 64 that is directed toward a primary tank 70 and a second belt 66 that is directed toward a secondary tank 72. When granules are being deposited in the primary tank 70 by the operation of the first belt 64 and the primary tank 70 reaches a predetermined full load weight, while the secondary tank 72 is less loaded than a full load weight, the first belt 64 may cease to operate and the second belt 66 may operate to transport the remainder of the load to the secondary tank 72.

A sensor may provide a signal to the processor-based device 100 to provide sensed conditions at one or more granule mesh storage positions 12, 14, 16. Sensors may sense various characteristics of the granule storage positions 12, 14, 16, or containers or tanks 70, 72 located at each storage position 12, 14, 16. Those sensors may sense content, level, or weight of granules in the storage positions 12, 14, 16, or containers or tanks 70, 72 containing granules in the storage positions 12, 14, 16, for example. Alternatively, one or more sensors may sense and indicate to the processor-based device 100 the remaining amount of capacity to which one or more granule mesh storage containers 70, 72 or sites can be filled before reaching a predetermined capacity limit.

The processor-based device 100 may furthermore control actuators or other devices at granule mesh storage positions, 12, 14, 16 including, for example, valve actuators 54 that operate valves 52 at inlets of storage tanks 70, 72 or containers.

Granules may be stored in tanks 70, 72 or other containers to prevent them from getting wet or otherwise contaminated or to enhance granule flow when granules are transferred from the storage positions 12, 14, 16. Tanks 70, 72 or containers may include valves 52 that are opened to allow filling of the tank 70, 72 or container and closed to prevent water or contaminants from entering the tank 70, 72 or container. The processor-based device 100 or an operator may open a valve 52 at the inlet of a tank 70, 72 or container before delivering granules to that tank 70, 72 or container and the processor-based device 100 or an operator gauge or other display 90 may be coupled to a sensor that provides information to the processor-based device 100 or operator that indicates whether the valve 52 has actually opened prior to placing additional granules in that tank 70, 72 or container. The processor-based device 100 may further determine that the target tank 70, 72 or container has capacity to receive additional granular material before transferring additional granular material to that tank 70, 72 or container or before opening the valve 52 to that tank 70, 72 or container. Once delivery of granules to the tanks 70, 72 or containers is accomplished, the processor-based device 100 or an operator may close the tank 70, 72 valves 52. Once a tank 70, 72 valve 52 is commanded to a closed position, the processor-based device 100 or an operator may sense or otherwise determine that the tank 70, 72 valve 52 has, in fact, closed.

Valves 52 in granule storage applications may not operate as commanded because, for example, granules have lodged in the valve 52 opening, or valve actuator 54. Thus, one or more position switches 54, potentiometers or other sensors may be provided at one or more of the valves 52 to sense the position of the valve 52. In one embodiment two binary-signal switches 54 are employed, the first of those two switches 54 sensing when the valve 52 is open and the second of those two switches 54 sensing when the valve 52 is closed. In another embodiment, an analog position sensor 56 senses the position of the valve 52 from open to closed, including degrees of partially opening. The switches 52 or position sensors may provide a signal to the processor-based device 100 or an operator display panel 78.

The processor-based device 100 may provide an alarm directly or from an output, for example to an operator, if a valve 52 that has been commanded to close is not confirmed closed by the valve sensor(s) 54 within a predetermined amount of time after the command to close is transmitted to the valve 52 and the processor-based device 100 may also provide an alarm, for example to an operator, if a valve 52 that has been commanded to open is not confirmed to be open within a predetermined amount of time after the command to open is transmitted to the valve 52.

Where a plurality of tanks 70, 72 or containers are employed at a granule mesh storage repository 12, 14, 16, those tanks 70, 72 or containers may be designated as primary and secondary, possibly tertiary, and additional designations where applicable. When additional granular material is to be added to a storage repository 12, 14, 16, an order in which the tanks 70, 72 or containers are to be filled may be predetermined and stored in the processor-based device 100. The processor-based device 100 may direct an operator to add a load of granular material to a particular one of the tanks 70, 72 or containers in a storage position 12, 14, 16 or convey a load to the predetermined tank 70, 72 or container.

In an embodiment, granular material, such as sand, of a desired mesh residing in a storage location or repository 12, 14, 16, possibly a tank 70, 72 or container, is removed from that storage location or repository 12, 14, 16, may be mixed with water, chemicals, or both, and is provided to a production site, such as a fracking well, for use at the production site.

The processor-based device 100 may, for example, communicate with the delivery person, the delivery container, or the delivery hauling vehicle to capture, for example from a separate processor-based device, such as an operator terminal 22, located on the delivery container or from a document presented to the processor-based device 100 by an operator delivering the granules, a signal that indicates one or more details about the granular material being delivered. For example, the processor-based device 100 may communicate with an operator terminal associated with a load of granules or read a code (e.g., QR or UCP) associated with the load of granules to determine what granules are being delivered in the load and how much of those granules are in the load.

Sand or granular material may be delivered to a site that uses such material, such as a fracking site, by trucks, such as dump trucks, in containers, such as sand boxes hauled on or behind a truck or other vehicle, train cars, or other carriers.

The processor-based device 100 or an on-site operator may further control access to a site by granular material haulers, thereby making an operation more efficient. Trucks hauling loads of granular material have been known to queue at a site that uses such granular material and to charge the owner of the site that uses such granular material for time spent waiting to unload. With the present granular material storage system 10, the processor-based device 100 may sense or an operator may determine the level of granular material contained at each granular material storage position 12, 14, 16. Storage of granular material at each granular material storage position 12,14,16 may include one or more tanks, such as two 10,000 or 20,000 gallon tanks 70, 72 with top openings in the embodiment illustrated in FIG. 1, that are provided at each granular material storage position 12, 14, 16. When, for example, the total amount of granular material contained in all tanks 70, 72 or other containers at a particular granular material storage position 12, 14, 16 fall below a predetermined level, the processor-based device 20 may inform an operator, whether an on-site or off-site operator, that additional granular material of the mesh stored in those tanks 70, 72 or containers or at that granular material storage position 12, 14, 16 is required. One or more loads of that mesh of granular material may then be dispatched to carry granular material of the desired mesh to refill those tanks 70, 72, containers or that repository 12, 14, 16. A truck, train car, sand box, or other transport carrying the desired mesh of granular material may then be allowed onto the site to deliver the desired mesh of granular material, while transports carrying other meshes of granular material are declined entry onto the site.

In an embodiment, the processor-based device 100 communicates with the operator terminal 22 or input device 25 to receive characteristics of a load of granular material, such as the quantity of granules in a current load, the source of the granules being delivered, the delivery company delivering the granules, the person delivering the granules, and the mesh size of the granules in the current load. The processor-based device 100 may also receive signals from weight sensors 41 measuring the weight of each tank 70, 72, or container and one or more valve position switches 56 sensing the position of each valve 52. The processor-based device 100 may furthermore be coupled to control conveyors 62, 64, 66, and valves 52 through the valve actuators 54. The processor-based device 100 may be coupled to the operator terminal 22, the input device 25, the various sensors 40, 56, and the various controlled devices 62, 64, 66, 54 by wires or wirelessly.

In an embodiment, the processor-based device 100 receives an entry signal notifying the processor-based device 100 that a delivery truck or other transport vehicle has passed a site entry, such as, for example, a gate, a receiving platform, a post, or an overhead bar. That entry signal provided to the processor-based device 100 may identify a truck entering a site using, for example RFID or a short-range wireless communication, such as Bluetooth or Zigbee. The processor-based device 100 may also receive lading information from the identified truck, such as quantity of granular material carried, mesh or size of carried granules, or other identifying characteristics of a load of granular material carried by the truck or other transport vehicle. The processor-based device 100 may acknowledge unloading of truck or other transport vehicle by, for example, receiving a binary or analog signal that granules carried have been deposited or otherwise successfully delivered. That delivery notification signal may provide, for example, a weight of granules delivered on a pad or a signal that the delivery vehicle has left the delivery site.

Once delivery has been completed, the processor-based device 100 may credit an account of a provider responsible for having the granules delivered for the delivery and that credit may, for example, be a financial credit that accounts, for example, for the amount of granules delivered multiplied by an agreed price to be paid per unit of granules of the particular type delivered. The processor-based device 100 may also dispatch the truck or other delivery vehicle with instructions for a next pick-up and delivery, or the processor-based device 100 may inform the truck operator and the operator's employer that no addition loads are required at this time.

The granular material delivery pad 20 may be a stationary or moving pad 20 on which granular material is deposited by a truck, train car, skid-steer loader, or other transport equipment or device. In one embodiment, the granular material delivery pad 20 is a continuous belt 22 that is moved by one or more rollers spaced to support the load deposited on the delivery pad 20 and rotatable to convey the deposited granules to a desired location by rotating rollers to move the belt and the granules thereon. In an embodiment, granules are moved from the delivery pad 20 to one or more conveyor belts 30, 32, 34 that, in turn may transport the granules to a desired destination 12, 14, 16. In another embodiment, the delivery pad be an initial transport in one or more series of transport devices 30, 32, 34 that terminate at a granular material storage position 12, 14, 16 or a granular material storage tank 70, 72. In embodiments, the delivery pad 20 is pivotable so as to be directed toward a single one of two or more different conveyor belts or transport devices 30, 32, 34; wherein each of those different transport devices 30, 32, 34 directs granules to a different granular material storage positions 12, 14, 16.

The delivery pad 20 may be pivoted through and within a range of angles so that the delivery pad 20 belt is directed toward and moving the granules toward a desired transport device 30, 32, 34 to convey the granules to a desired destination 12, 14, 16.

In an embodiment, the granule transfer and storage system 10 includes the granule receiving platform or pad 20 and the granule transfer device 30 for transfer of granules from the granule receiving platform 20 to one or more small mesh granule storage tanks 70, 72 or other containers at a small mesh granule storage site 12 or one or more large mesh granule storage tanks 70, 72 or other containers at a large mesh storage site 16. It should be recognized that a medium mesh storage site 14 containing one or more medium mesh granule storage tanks 70, 72 or other containers may be present in addition to the small mesh site 12 and the large mesh site 16 and other gradations of granule storage tanks 70, 72 of sites 12, 14, 16 may be present. The granule transfer device 30 may furthermore operate to deliver granules to the medium mesh site 14 and other sites present.

The granule transfer device 30 may comprise separate conveyors 30, 32, 34 that deliver granules to each of the granule storage repositories 12, 14, 16 and to each of the tanks 70, 72 or containers or the granule transfer device 30 may be adjustable such that one or more conveyors 30, 32, 34 can be adjusted for delivery of granules to certain or any desired site 12, 14, 16, tank 70, 72, or container.

Each tank 70, 72 or container at each storage site 12, 14, 16 may include a closure device to prevent ingress of rain and other undesirable contaminants. The closure device may take the form of a valve 52, a damper, a plate, or any other desired closure device, all referred to herein as a valve 52. Those closure devices may be attached to actuators 54 that open, close, modulate or otherwise actuate the closure device. For example, a damper type valve 52 may be opened to permit filling of a tank 70, 72 or container and closed to prevent contamination of that tank 70, 72 or container using an electric, a pneumatic, or a hydraulic powered actuator 54.

In an embodiment, a small mesh storage site 12 includes two tanks 70, 72 for storage of small mesh granules, a medium mesh storage site 14 includes two other tanks 70, 72 for storage of medium mesh granules, and a large mesh storage site 16 includes two other tanks 70, 72 for storage of large mesh granules. Each tank 70, 72 in that embodiment may include a valve 52 or other closure device and an actuator 54 to open and close or modulate the valve 52 or other closure device.

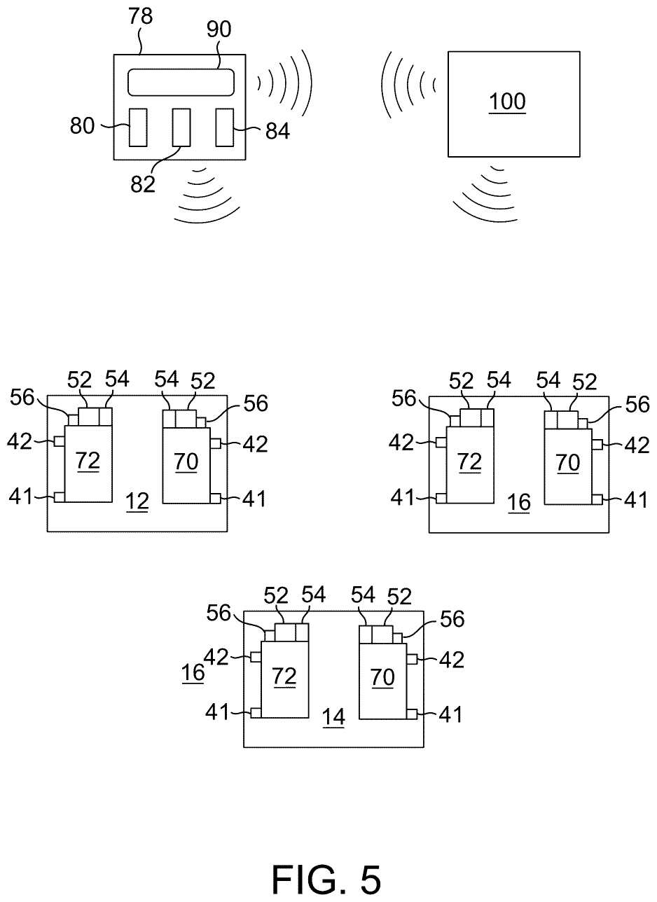

FIG. 5 illustrates elements 76 that may be used in operation of a granule transfer and storage apparatus 10. Those operative elements 76 may include a processor-based device 100 or a control panel 78 to control operation of conveyors e.g., 30, 32, 34 and valves 52 and actuators 54 associated with a a granule transfer and storage apparatus 10.

The granule transfer and storage apparatus 10 may operate using switches, such as the small mesh transfer switch 80, the medium mesh transfer switch 82, and the large mesh transfer switch 84 illustrated in FIG. 5 on control panel 78. For example, in an embodiment, a truck 210 or other carrier may deliver a load of granules. A site operator may review a bill of lading or other document or physically inspect the load of granules to determine the size of the mesh of the granules and that may lead the site operator to a determination of where the granules should be stored. If the load of granules is desired at the site 18, the site operator may instruct the carrier operator to unload the granules on the granule receiving platform 20. The site operator may then actuate a switch, such as a small mesh switch 80, a medium mesh switch 82, or a large mesh switch 84, to deliver granules on the granule receiving platform 20 to an appropriate repository 12, 14, 16 or an appropriate tank 70, 72. The switch 80, 82, 84 may open a valve 52 on the desired tank 70, 72 and may energize a conveyor 30, 32, 34 to carry the granules to the desired tank 70, 72. Alternatively, the switch 80, 82, 84 may open a valve 52 on the desired tank 70, 72 and an open switch 56 at the valve 52 may energize the appropriate conveyor 30, 32, 34 to deliver granules to the desired tank 70, 72 when the valve open switch 56 indicates that the valve 52 is open for that tank 70, 72.

It should be recognized that such switches 80, 82, 84 may be connected as inputs to a processor-based device 100 or may directly energize various apparatuses 52, 30, 32, 34 directly, as in a traditional control system.

In certain embodiments, a valve closed switch 56 is located adjacent one or more of the valves 52 to confirm or indicate that the valve 52 associated with the valve closed switch 56 has closed. A signal from that valve closed switch 56 may be provided to the processor-based controller 100 or an audio or visual indicator may be associated with a control panel 78 or operator display 90. In an example embodiment, the small mesh granule transfer switch 80 actuates the first small mesh granule valve actuator 54 to close the first small mesh valve 52 when the small mesh transfer switch 80 is placed in an off position. When the small mesh transfer valve 52 is closed, the small mesh valve closed switch 56 may indicate that the small mesh valve 52 has successfully closed and that closure may be transmitted to the processor-based controller 100 or the control panel 78 or operator display 90. Where a valve 52 is commanded to close and the closed switch 56 for that valve 52 does not indicate that the valve 52 successfully closed, a person may be dispatched to resolve the situation by removing debris from the valve 52 of taking other action and the person may manually close the valve 52. Similar devices and operation may be provided at large, medium, or other granule mesh valves 52.

Thus, an embodiment of the differential granular storage apparatus is used with a processor-based device 100, the processor-based device 100 also referred to herein as a programable logic controller or simply a controller. The processor-based device 100 may include a plurality of inputs and a plurality of outputs. In one such embodiment, a first switch 56 is coupled to a first input of the controller and provides a signal to the controller 100 that indicates whether the first small mesh granule valve 52 is open. A second switch 56 is coupled to a second input on the controller 100 and provides a signal to the controller 100 that indicates whether the first small mesh granule valve 52 is closed. A first output is coupled to the first small mesh granule valve actuator 54 to control the first small mesh granule valve 52. Where small and large mesh granules are being separately stored, a third switch 56 is coupled to a third input on the controller 100 and provides a signal to the controller 100 that indicates whether the first large mesh granule valve 52 is open, a fourth switch coupled to a fourth input on the controller 100 may provide a signal to the controller 100 that indicates whether the first large mesh granule valve 52 is closed, and a second output of the controller 100 may be coupled to the first large mesh granule valve actuator 54 to control the first small mesh granule valve 52.

In certain embodiments, a first sensor 56 is coupled to an input of the controller 100 and provides a signal to the controller 100 that indicates a degree of openness of the small mesh valve 52 and a second sensor 56 is coupled to the controller 100 and provides a signal to the controller 100 that indicates a degree of openness of the large mesh valve 52.

In an embodiment, one or more tanks 70, 72 on each site 12, 14, 16 include a capacity sensor 41. The capacity sensor 41 may be a level sensor, a weight sensor 40, or another sensor that determines a portion to which the tank 70, 72 being sensed is filled. That capacity sensor 41 may be coupled to the controller 100 or to an indicator, such as on a control panel 78 accessible to the site operator to provide available capacity in the tank 70, 72 for a decision to be made as to whether to deposit granules in that tank 70, 72.

In an embodiment in which a capacity sensor 41 is coupled to the controller 100, the controller 100 may make a decision that granules of an appropriate size be placed in a tank 70, 72 where the capacity, for example weight sensor 42, indicates that that tank 70, 72 is not full and has capacity to accept additional granules. When the tank capacity sensor 41, such as the wight sensor 42 indicates that the tank 70, 72 weight has reached a predetermined capacity limit, the controller 100 may stop conveying granules to that tank 70, 72 and direct additional granules to a backup tank or other tank 70, 72 located at the appropriate granule mesh site 12, 14, 16.

In various embodiments, conveyors 30, 32, 34, may be provided to transport granules from the granular material delivery pad 20 to various sites 12, 14, 16 and tanks 70, 72. In certain of those embodiments, one or more conveyors 30, 32, 34, 64, 66 may be adjustable such that a conveyor 30, 32, 34, 64, 66 may transport granules from the granular material delivery pad 20 to more than one site or tank 70, 72. In one embodiment, a separate conveyor 30, 32, 34 is provided to transport granules to each of the granule mesh sites 12, 14, 16. In certain of those embodiments wherein a separate conveyor 30, 32, 34 is provided to transport granules to each of the granule mesh sites 12, 14, 16, separate conveyors 30, 32, 34 are provided to transport granular material from the granular material delivery pad 20 to a specific tank 70, 72. In another embodiment wherein a separate conveyor 30, 32, 34 is provided to transport granules to each of the granule mesh repositories 12, 14, 16, one or more conveyors 30, 32, 34 is provided to transport granular material to each site 12, 14, 16 and deposit the granular material on one of a plurality of final destination conveyors 64, 66 that each transports granular material to a specific tank 70, 72 or container on that site 12, 14, 16.

Thus, in an embodiment a first conveyor 30 extends from the granular material delivery pad 20 to the small mesh granule repository 12 and a second conveyor 32 extends from the granular material delivery pad 20 to the large mesh granule site 16. From the small mesh granule site 12 end of the first conveyor 30, a third conveyor 64 may extend to a first small mesh tank 70 or container located at the small mesh granule repository 12 and a fourth conveyor 66 may extend from the small mesh granule site 12 end of the first conveyor 30 to a second small mesh tank 72 or container. Similarly, from the large mesh granule site 16 end of the second conveyor 34, a fifth conveyor 64 may extend to a first large mesh tank 70 or container located at the large mesh granule site 16 and a sixth conveyor 66 may extend from the large mesh granule repository 16 end of the second conveyor 34 to a second large mesh tank 72 or container.

In one embodiment, sand or other granular material may be placed in a tank 70, 72 designated to receive granules of the mesh that is being delivered by vacuum or pressure applied to the granules to move the granules into the appropriate or desired tank 70, 72.

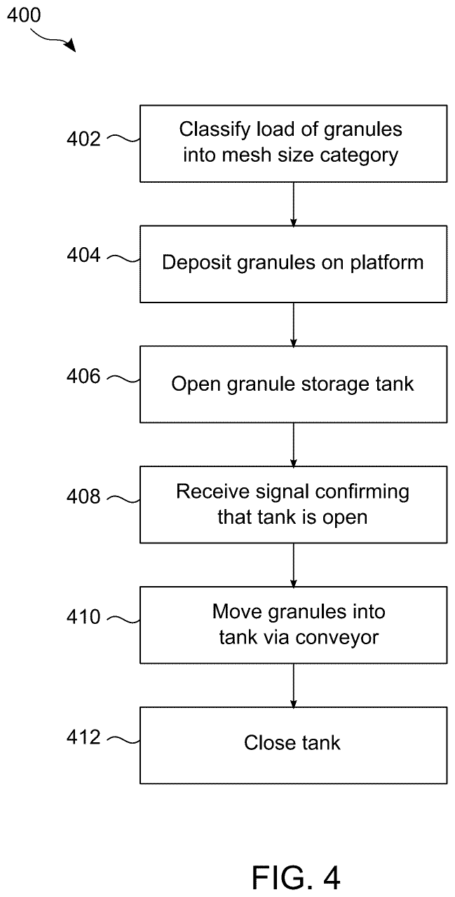

FIG. 3 illustrates an embodiment of a processor-based controller 600 for use in a granular material storage system 10. The processor-based controller 600 may, for example, be a microcontroller, an application specific integrated circuit, a general-purpose computer, or a programable logic controller, such as those manufactured by Rockwell International under the Allen Bradley trademark. In the embodiment illustrated in FIG. 4, the processor-based device 600 includes a processor 602 and a communication device 612. The processor 602 and communication device 612 can be combined in a microprocessor or other device and other components (e.g., 604 and 606) may also be included in such a microprocessor or other device.

The communication device 612 may be wired to a device to which it communicates. The communication device 612 may, in addition or alternatively, wirelessly communicate with one or more other devices over a network 622, which may be a wireless network, such as a mobile smartphone network, a short-range wireless protocol, such as Bluetooth or Zigbee, or another desired communication protocol, and the communication device 612 may operate both wired and wirelessly. The processor-based device 600 may furthermore include memory 604, an input 610 that may receive an input signal, such as a signal transmitted by a sensor, and an output 608 that may transmit a control signal, instruction, or data to another device, such as a valve actuator or other controlled device.

The processor-based device 600 may also be coupled to a user interface 632 to receive one or more signals from, for example, one or more of a keyboard, touch screen, mouse, microphone or other input device or technology and may have associated software. The user interface 632 may also transmit information to, for example, a printer or screen coupled to the user interface 632 or the output 608.

The memory 604 may, for example, include random-access memory (RAM), flash RAM, dynamic RAM, or read only memory (ROM) (e.g., programmable ROM, erasable programmable ROM, or electronically erasable programmable ROM) and may store computer program instructions and information. In embodiments, the memory 604 may be partitioned into sections including an operating system partition 616 where system operating instructions are stored, a data partition 618 in which data, may be stored, and a signal modification module 620 that may be used to convert sensor signals into human readable engineering units.

The storage device 606 may include a memory device or a data storage device or a combination of both memory and data storage devices, or another device or devices for storage of data. The data storage 606 may be considered local storage when the data is stored directly on the processor-based device 600 or the data may be accessible to the processor-based device 606 over a wired or a wireless network. The storage device 606 may furthermore include a computer readable storage medium that includes code executable by the processor 602, which may be used, for example, to cause the processor 602 to, at least in part, store sand and similar materials as disclosed herein.

In an embodiment, the storage device 606 for the processor-based device 600 may include a combination of flash storage and RAM. The storage device 606 may also include a computer readable storage medium and may include code executable by the processor 602.

In an embodiment, the elements, including the processor 602, communication adaptor 612, memory 604, input device 610, output device 608, and data storage device 606 may communicate by way of one or more communication busses 614. Those busses 614 may include, for example, a system bus or a peripheral component interface bus.

The processor 602 may be any desired processor and may be a part of a controller 600 or a microcontroller, may be part of or incorporated into another device, or may be a separate device. The processor 602 may, for example, be an Intel® manufactured processor or another processor manufactured by, for example, AMD®, DEC®, or Oracle®. The processor 602 may furthermore execute the program instructions and process the data stored in the memory 604. In one embodiment, the instructions are stored in the memory 604 in a compressed or encrypted format. As used herein the phrase, “executed by a processor,” is intended to encompass instructions stored in a compressed or encrypted format, as well as instructions that may be compiled or installed by an installer before being executed by the processor 602.

The data storage device 606 may be, for example, non-volatile battery backed static random-access memory (RAM), a magnetic disk (e.g., hard drive), optical disk (e.g., CD-ROM) or any other device or signal that can store digital information. The data storage device 606 may furthermore have an associated real-time clock, which may be associated with the data storage device 606 directly or through the processor 602. The real-time clock may trigger data from the data storage device 606 to be sent to the processor 602, for example, when the processor 602 polls the data storage device 606. Data from the data storage device 606 that is to be sent across the network 622 through the processor 602 may be sent in the form of messages in packets if desired. Those messages may furthermore be queued in or by the processor 602.

The communication adaptor 612 permits communication between the processor-based device 600 and other nodes, such as a tanker truck controller 40 or a remote monitoring peripheral computer 22, 25, illustrated in FIG. 2, or another computing device or server. The communication adaptor 612 may be a network interface that transfers information from a node such as a networked device, which may include an actuating device such as an actuator 54 for a valve 52 or a sensing device 40, 41, 56, to the tanker truck controller 40, the remote monitoring peripheral computer 22, 25, 100, a general-purpose computer (not illustrated), a user interface 632, or another node. The communication adaptor 612 may be an Ethernet adaptor or another adaptor for another type of network communication. It will be recognized that the processor-based device 600 may alternatively or in addition be coupled directly to one or more other devices through one or more input/output adaptors (not shown).

The processor-based control device 600 may communicate and may have its memory 604 or processes modified by a user interface 632. That user interface 632 may be, for example, a computer; a tablet; a mobile smartphone device (referred to herein as a phone); an application specific user interface device; or another device that can be used to transfer information to the controller 600 or receive information from the controller 600.

The granular material storage system 10 may have its sensors (e.g., 40, 41, 56) encapsulated in a probe housing that may be inserted into a tank 70, 72 or conduit associated with a tank 70, 72, or the sensors may be situated on, under or around a tank 70, 72. The controller 100 may provide continuous monitoring of the granular material storage system 10 and may provide for remote monitoring of the granular material storage system 10. In certain embodiments, the granular material storage system 10 may include cellular or satellite connectivity so that the system can be accessed from anywhere in the world allowing for visibility into condensate concentrations and alarm conditions.

The switches 80, 82, 84, gauges and displays 90 and processor-based controller 100, 600 may be housed in a Class1/Div2 or Class1/Div1 enclosure for deployment in hazardous areas or another desired enclosure, and the granular material storage system 10 may be outfitted with a self-cleaning function tailored to granular material storage to ensure that it does not lose detection ability due to plating or fouling. The granular material storage system 10 may be powered by a nominal 110VAC power supply or another desired electrical power supply. The granular material storage system 10 may include or be housed in an enclosure that is sealed against entry of moisture and solid material and debris and may be surge protected to protect against electrical overload. Communications between the granular material storage system 10 may furthermore be password protected with unique passwords. Those passwords may relate to a customer, organization, site, or otherwise as desired to restrict access to information to those having a legitimate interest in the information to be shared between devices.

The granular material storage system 10 may also include one or more indicators 634 that extend through its enclosure to provide operational information to an onlooker. For example, the indicators 634 may include one or more LEDs that indicate information such as operating status of the valves 52 or tanks 70, 72 and communication between the processor-based device 100 and another node. The indicators 634 may furthermore include one or more readouts that indicate, for example, the signal being received by the processor-based device 100 or the signal being or to be transmitted by the processor-based device 100.

The granular material storage system 10 may also include a sensor cleaning system to remove hydrocarbons, solid impurities, or other foreign materials from the sensors 40, 41 and 56. In an embodiment, that cleaning system may draw 1HP of power and create 7 CFM of airflow across the sensors 40, 41, and 56, at 90 psi.

Regarding identification provided when a tanker truck 210 or other carrier approaches a site or a granular material delivery pad 20, the truck 210 or tank 212 may be identified by any unique identifier of the tank 212 or the truck 210 on which a particular tank 212 is mounted and may be recognized in a variety of ways. For example, a user interface may be used to identify the tank 212 currently in position to unload or otherwise operate by way of a wired or wireless transmission from an electronic device associated with the tank 212 or associated truck 210. A unique identifier may be transmitted from the tank 212 or associated truck 210 by any signal transmitting device, or an identifier may be read and transmitted by a geofencing or other position determination device that senses the presence of the tank 212 or its associated truck 210. Alternatively, a driver or operator may enter the tank identifier into a device to recognize a tank 212 that is currently under operation.

In an embodiment, a tanker truck driver will carry an electronic fob or other device 40 that contains a name or an identification of the driver, the company that operates the truck 210, a truck 210 identifying number, or any other tanker truck 210 related information desired, such as a quantity, type, or mesh of granular material carried by the truck tank 212 or a capacity of the tank 212, and transmits that identification to an appropriate communicating node at, or remote from, the site.

FIG. 4 illustrates an embodiment of a method of transferring and storing different size or mesh of granules 400. The method may be performed by a human operator using a control panel 78 or, where additional detail or precision are required than cannot be expected to be processed and formulated by a human operator, by a processor-based device 100. At 402, in a method performed by a processor-based device 100, a load of granules is classified in one of a plurality of mesh size categories. Categorization may be performed at least in part by reading or receiving at a processor-based controller 100, for example using an RFID reader, a code that indicates the mesh of the granules. The reading or receiving may be accomplished from a transmission of a signal from a user terminal 22, an RFID tag, or another device 25. Other information may also be included in the transmission to the processor-based controller 100, including, for example, quantity of granules in the load and delivery information. At 404 a carrier, such as a truck 210 deposits granules on the granule receiving platform 20. At 406, the processor-based device 100 opens a tank 70, 72 or other container at the repository 12, 14, 16 where the granules are to be stored. At 408, the processor-based device 100 may receive a signal confirming that the tank 70, 72 or other container is open to receive the granules and at 410, the processor-based device 100 may energize a conveyor or other moving apparatus to move the granules into the tank 70, 72. At 412, the tank 70, 72 or other container is closed once the granules have been placed in the tank 70, 72 or other container.

In another embodiment, a granule delivery system manages the granule delivery process. In that embodiment, a vehicle sensor is located at a granule processing site entrance. That vehicle sensor identifies that a granule delivery vehicle passes the site entrance and identifies the specific delivery vehicle that is passing the site entrance.

The vehicle sensor is coupled by wire or wirelessly to a processor-based device 100 and that processor-based device 100 includes instruction which, when executed, cause the processor-based device 100 to perform various functions. Those functions may include receiving a signal from the vehicle sensor and that signal may alert the processor-based device 100 that a vehicle, such as a granule delivery truck, has passed the site entrance. The vehicle sensor may alternatively or in addition alert the processor-based device 100 of the identity of the specific delivery vehicle that is passing the site entrance. The processor-based device 100 may also receive additional information from the identified carrier vehicle sensor, or another device or transmission received from the identified vehicle, including lading information regarding the material carried by the identified vehicle, and acknowledgement that the vehicle unloaded the carried material. The processor-based device 100 may also transmit dispatch instructions for further operation of the identified vehicle.

The granule delivery system may also include a granule quantity sensor coupled to the processor-based device 100 to transmit granule quantity sensed to the processor-based device 100. The granule quantity measurement device is under, in or otherwise associated with the delivery pad 20. The granule quantity measurement device may furthermore be a scale or otherwise measure the weight of material deposited on the delivery pad 20.

The granule delivery system vehicle sensor may be located at various locations to sense or communicate with a truck 200 or other delivery vehicle, including at a gate to the site, at a receiving platform, on an overhead bar the vehicle passes under when entering the site, or on a post near the entrance to the site. The vehicle sensor may furthermore comprise an RFID transmitter, a magnetic sensor, an inductive loop embedded in the surface of the roadway, an infrared sensor, a microwave sensor, or a camera and may include a communication device, such as a global positioning device, a geofencing transmitter, a Wi-Fi data transmitter, a short-range wireless beacon, a Bluetooth enabled device, a ZigBee enabled device, a cellular data transmitter, and another wireless communication device.

Lading information related to a load of material being delivered to a site by a truck 200 of other vehicle may include the mesh of the granules carried by the identified vehicle, the type of granules carried, the quantity of granules carried, the volume of granules carried, the weight of granules carried, the price of the granules carried, any discount provided for the granules carried, the source of the granules carried, the name of the carrier delivering the granules, the name of the driver of the carrying vehicle, and the source of the granules.

The carrier vehicle in the granule delivery system may be any delivery vehicle including, for example, a any of various types of truck 200, a train, a freight car, and a barge.

The granule delivery system may dispatch a carrier delivery vehicle to perform a task. Such dispatch my include instructions to transport another load to the site and provide direction regarding details of what is to be carried to the site and where the material is to be obtained. Another dispatch may inform on operator of the carrier vehicle 200 that no additional transport is required at this time.

The granule delivery system may acknowledge that a load of material has been delivered to the site by, for example, sensing a carrier vehicle 200 passing a sensor when departing the delivery pad, transmitting that a carrier vehicle has actuated a switch by placing granules on the delivery pad, or by through a sensor for measuring granules unloaded on the delivery pad 20.

The granule delivery system may further include the processor-based device 100 calculating remuneration for a delivered load and financially crediting an account associated with the delivery. Such a financial credit bay e based on various information, including, the value of the mesh of granules delivered and the quantity of granules delivered.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A granule transfer and storage apparatus, comprising:
a granule receiving platform;
a granule transfer device; a small mesh granule storage site having a first small mesh granule storage container; a large mesh granule storage site having a first large mesh granule storage container;
a first small mesh granule valve that allows and restricts access to the first small mesh granule storage container; a first small mesh granule valve actuator that opens the first small mesh granule valve to permit small mesh granules to enter the small mesh granule storage container and that closes the first small mesh granule storage valve to prevent entry of materials to the first small mesh storage container; a first large mesh granule valve that allows and restricts access to the first large mesh granule storage container; and
a first large mesh granule valve actuator that opens the first large mesh granule valve to permit large mesh granules to enter the large mesh granule storage container and that closes the first large mesh granule storage valve to prevent entry of materials to the first large mesh storage container.

2. The granule transfer and storage apparatus of claim 1, wherein:
the granule transfer device transfers granules to the small mesh granule storage site; and further comprising:
a second granule transfer device that transfers granules to the large mesh granule storage site.

3. The granule transfer and storage apparatus of claim 1, further comprising:
a small mesh granule transfer switch that, when placed in an on position:
actuates the first small mesh granule valve actuator to open the first small mesh valve; and
energizes the granule transfer device to carry granules placed on the granule receiving platform to the first small mesh granule storage container; and
a large mesh transfer switch that, when placed in an on position:
actuates the first large mesh granule valve actuator to open the first large mesh valve; and
energizes the granule transfer device to carry granules placed on the granule receiving platform to the first large mesh granule storage container.

4. The granule transfer and storage apparatus of claim 3, further comprising:
a first small mesh valve open switch that has a first state that indicates that the first small mesh valve is open and a second state that indicates that the first small mesh valve is not open and that energizes the granule transfer device to carry granules to the first small mesh granule storage container only when the first small mesh open switch indicates that the first small mesh valve is open; and
a first large mesh valve open switch that has a first state that indicates that the first large mesh valve is open and a second state that indicates that the first large mesh valve is not open and that energizes the granule transfer device to carry granules to the first small mesh granule storage container only when the first large mesh open switch indicates that the first large mesh valve is open.

5. The granule transfer and storage apparatus of claim 4, wherein:
the small mesh granule transfer switch actuates the first small mesh granule valve actuator to close the first small mesh valve when the small mesh transfer switch is placed in an off position; and
the large mesh granule transfer switch actuates the first large mesh granule valve actuator to close the first large mesh valve when the large mesh transfer switch is placed in an off position.

6. The granule transfer and storage apparatus of claim 1, further comprising a controller, wherein:
the controller contains instructions that, when executed by the controller cause the controller to receive a signal that indicates the mesh size of granules to be transferred to and stored by the granule transfer and storage apparatus.

7. The granule transfer and storage apparatus of claim 6, further comprising:
a plurality of inputs and a plurality of outputs coupled to the controller;
a first switch coupled to a first controller input and providing a signal to the controller that indicates whether the first small mesh granule valve is open;
a second switch coupled to a second controller input and providing a signal to the controller that indicates whether the first small mesh granule valve is closed;
a first controller output coupled to a first small mesh granule valve actuator to control the first small mesh granule valve in accordance with instructions that, when executed by the controller, cause the controller to actuate the first small mesh granule valve actuator;
a third switch coupled to a third controller input and providing a signal to the controller that indicates whether the first large mesh granule valve is open;
a fourth switch coupled to a fourth controller input and providing a signal to the controller that indicates whether the first large mesh granule valve is closed;
a second output coupled to a first large mesh granule valve actuator to control the first large mesh granule valve in accordance with instructions that, when executed by the controller, cause the controller to actuate the first large mesh granule valve actuator.

8. The granule transfer and storage apparatus of claim 6, further comprising:
a first sensor coupled to a first input of the controller and providing a signal to the controller that indicates a degree of openness of the first valve; and
a second sensor coupled to a second input of the controller and providing a signal to the controller that indicates a degree of openness of the second valve.

9. The granule transfer and storage apparatus of claim 1 wherein the granule transfer device includes a conveyor that transports granules from the granule receiving platform to one of the small mesh granule storage site and the large mesh granule storage site.

10. The granule transfer and storage apparatus of claim 9, wherein
the small mesh granule storage site includes a first small mesh storage tank and a second small mesh storage tank; and
the large mesh granule storage site includes a first large mesh storage tank and a second large mesh storage tank;
and granule transfer and storage apparatus includes a third conveyor directed from the first conveyor to the first small mesh granule storage tank;
a fourth conveyor directed from the first conveyor to the second small mesh storage tank;
a fifth conveyor directed from the second conveyor to the first large mesh granule storage tank; and
a sixth conveyor directed from the second conveyor to the second large mesh storage tank.

11. The granule transfer and storage apparatus of claim 7, further comprising:
a receiver coupled to the controller to receive at least one signal indicating:
a mesh size of the granules being deposited on the granule receiving platform; and
a quantity of granules being deposited on the granule receiving platform.

12. The granule transfer and storage apparatus of claim 7, further comprising:
a first fill sensor coupled to a fifth input of the controller and indicating an extent to which the first small mesh granule tank is filled;
a second fill sensor coupled to a sixth input of the controller and indicating an extent to which the second small mesh granule tank is filled;
a third fill sensor coupled to a seventh input of the controller and indicating an extent to which the first large mesh granule tank is filled; and
a fourth fill sensor coupled to an eighth input of the controller and indicating an extent to which the second large mesh granule tank is filled; and
wherein granules are not deposited in a tank when the tank is full to a predetermined portion of its capacity.

13. A method of transferring and storing different size granules, comprising:
categorizing the granule by size;
depositing the granules on a granule receiving platform;
opening a container for the granules;
transferring the granules to a site designated for granules of the size of the granules deposited on the granule receiving platform;
placing the granules in the container; and
closing the container.

14. A granule delivery system, comprising:
a vehicle sensor located at a granule processing site entrance that identifies that a granule delivery vehicle passes the site entrance and identifies the specific delivery vehicle that is passing the site entrance; and a processor-based device having instructions that, when executed, cause the processor-based device to: receive at least one signal from the vehicle sensor identifying the vehicle that passes the site entrance;
receive lading information regarding the material carried by the identified vehicle;
receive acknowledgement that the vehicle unloaded the carried material; and transmit dispatch instructions for further operation of the identified vehicle.

15. The granule delivery system of claim 14, wherein the vehicle sensor is located at one of a gate, a receiving platform, an overhead bar, and a post.

16. The granule delivery system of claim 14, wherein the vehicle sensor is at least one of an RFID transmitter, a magnetic sensor, an inductive loop embedded in the surface of the roadway, an infrared sensor, a microwave sensor, and a camera.

17. The granule delivery system of claim 14, wherein the vehicle sensor is at least one of a global positioning device, a geofencing transmitter, a Wi-Fi data transmitter, a short-range wireless beacon, a Bluetooth enabled device, a ZigBee enabled device, a cellular data transmitter, and another wireless communication device.

18. The granule delivery system of claim 14, wherein the lading information includes at least one of the mesh of the granules carried by the identified vehicle, the type of granules carried, the quantity of granules carried, the volume of granules carried, the weight of granules carried, the price of the granules carried, any discount provided for the granules carried, the source of the granules carried, the name of the carrier delivering the granules, the name of the driver of the carrying vehicle, and the source of the granules.

19. The granule delivery system of claim 14, wherein transmitting dispatch instructions includes at least one of dispatching the delivery vehicle to transport another load to the site and instructing the transport operator that no additional transport is required at this time.

20. The granule delivery system of claim 14, wherein acknowledging unloading of the identified vehicle includes at least one of the vehicles passing a sensor when departing the delivery pad, a switch actuated by placing granules on the delivery pad, and a sensor for measuring granules unloaded on the delivery pad.
